(19) United States
(12) Patent Application Publication
(10) Pub. No.: US 2024/0095559 A1
(43) Pub. Date: Mar. 21, 2024

(54) STEADY RANGE DETERMINATION SYSTEM, STEADY RANGE DETERMINATION METHOD, AND COMPUTER READABLE MEDIUM

(71) Applicant: Mitsubishi Electric Corporation, Tokyo (JP)

(72) Inventors: Masaaki AOKI, Tokyo (JP); Masahiko SHIBATA, Tokyo (JP)

(73) Assignee: Mitsubishi Electric Corporation, Tokyo (JP)

(21) Appl. No.: 18/524,446

(22) Filed: Nov. 30, 2023

Related U.S. Application Data
(63) Continuation of application No. PCT/JP2021/027357, filed on Jul. 21, 2021.

(51) Int. Cl. G06N 7/01; G06Q 10/04; G06Q 50/04

(52) U.S. Cl. CPC G06N 7/01; G06Q 10/04; G06Q 50/04

(57) ABSTRACT

A steady range determination device (100) determines a steady range of a multilevel signal in operation data containing the multilevel signal. A conversion unit (122) converts the multilevel signal into at least one binary signal with using a threshold value. A prediction unit (123) inputs the binary signal converted by the conversion unit (122) to a prediction model (133) and calculates a converted binary signal prediction value. A range determination unit (126) calculates, based on the converted binary signal prediction value and the threshold value, a probability that a signal value of the multilevel signal contained in the operation data exists in a range determined based on the threshold value. The range determination unit (126) determines the steady range of the multilevel signal contained in the operation data, on a basis of the probability.

### CROSS REFERENCE TO RELATED APPLICATION

This application is a Continuation of PCT International Application No. PCT/JP2021/027357, filed on Jul. 21, 2021, which is hereby expressly incorporated by reference into the present application.

### TECHNICAL FIELD

The present disclosure relates to a steady range determination system, a steady range determination method, and a steady range determination program. In particular, the present disclosure relates to a steady range determination system, a steady range determination method, and a steady range determination program which determine a steady range of a multilevel signal in operation data.

### BACKGROUND ART

In a conventional factory, when a trouble such as stoppage of a production line occurs, maintenance personnel at the factory identify the cause of the trouble on a basis of their knowledge or experience and take appropriate measures. However, it is often difficult to identify the cause from among an enormous amount of operation data and complicated programs and to quickly solve the trouble. In addition, it is difficult to set up or create a program for comprehensively identifying the cause of the trouble with a realistic number of man-hours.

Patent Literature 1 discloses a system for the maintenance personnel to obtain clues for specifying a sensor or a program that causes trouble without setting exhaustive conditions. Patent Literature 1 discloses a system that automatically detects unsteady temporal changes in a binary signal that expresses two values such as ON and OFF of a sensor and in a multilevel signal such as a current value and a pressure value, which takes values other than 0 and 1.

### CITATION LIST

### Patent Literature

Patent Literature 1: Japanese Patent No. 6790311

### SUMMARY OF INVENTION

### Technical Problem

The method of Patent Literature 1 converts a multilevel signal into a binary signal, predicts a normal value of the binary signal, and detects an unsteady change in the signal. When an unsteady change is detected in the multilevel signal, an unsteady portion of the converted binary signal is specified, and a value that the multilevel signal should take in a steady state is obtained as a prediction value. However, it is not possible to discriminate at a glance how the multilevel signal before conversion into the binary signal takes an unsteady value. When a trouble such as stoppage of a production line occurs, it is necessary to check how the value of the multilevel signal differs from that in the normal state in order to identify the cause of the trouble.

In the present disclosure, a steady range of a multilevel signal is determined based on a probability that a signal value of the multilevel signal exists in a range determined based on a threshold value. An objective of the present disclosure is to thereby display in an easy-to-understand manner to an operator what signal value the multilevel signal takes as compared with the steady range.

### Solution to Problem

A steady range determination system according to the present disclosure which determines a steady range of a multilevel signal in operation data containing the multilevel signal includes:
a conversion unit to set at least one threshold value for the multilevel signal contained in the operation data, and to convert the multilevel signal into at least one binary signal with using the threshold value;
a prediction unit to input the binary signal converted by the conversion unit to a prediction model which predicts a steady-state signal value of the operation data, and to calculate a prediction value of the binary signal converted by the conversion unit, as a converted binary signal prediction value, and
a range determination unit to calculate, based on the converted binary signal prediction value and the threshold value, a probability that a signal value of the multilevel signal contained in the operation data exists in a range determined based on the threshold value, and to determine the steady range of the multilevel signal contained in the operation data, on a basis of the probability.

### Advantageous Effects of Invention

A steady range determination system according to the present disclosure determines a steady range of a multilevel signal on a basis of a probability that a signal value of the multilevel signal exists in a range determined based on a threshold value. Therefore, with the steady range determination system according to the present disclosure, the steady range of the multilevel signal can be determined appropriately, and what signal value the multilevel signal takes as compared to that in the steady range can be displayed in an easy-to-understand manner to an operator.

### BRIEF DESCRIPTION OF DRAWINGS

FIG. 1 is a diagram illustrating a configuration example of a steady range determination system according to Embodiment 1.

FIG. 2 is a diagram illustrating a configuration example of a steady range determination device according to Embodiment 1.

FIG. 3 is a diagram illustrating a functional configuration example of a model generation unit according to Embodiment 1.

FIG. 4 is a diagram illustrating a functional configuration example of a determination unit according to Embodiment 1.

FIG. 5 is an overall flowchart of a steady range determination process by the steady range determination device according to Embodiment 1.

FIG. 6 is a diagram illustrating a specific example of a conversion process according to Embodiment 1.

FIG. 7 is a diagram illustrating an example of input/output of a prediction model according to Embodiment 1.

FIG. 8 is a diagram illustrating an example in which prediction values of one signal are outputted in a time-series manner in a prediction process according to Embodiment 1.

FIG. 9 is a diagram illustrating an example in which prediction values in three signals are outputted in a time-series manner in the prediction process according to Embodiment 1.

FIG. 10 is a diagram illustrating an example of calculating a probability that a signal value of a multilevel signal according to Embodiment 1 exists in a range.

FIG. 11 is a detailed flowchart of a process of calculating an in-range probability of the signal value of the multilevel signal according to Embodiment 1.

FIG. 12 is a diagram illustrating a specific example of a first determination method of the steady range determination process according to Embodiment 1.

FIG. 13 is a flowchart illustrating an example of a second determination method of the steady range determination process according to Embodiment 1.

FIG. 14 is a flowchart illustrating another example of the second determination method of the steady range determination process according to Embodiment 1.

FIG. 15 is a diagram illustrating a specific example of a third determination method of the steady range determination process according to Embodiment 1.

FIG. 16 is a diagram illustrating a specific example of a fifth determination method of the steady range determination process according to Embodiment 1.

FIG. 17 is a diagram illustrating a configuration example of a steady range determination device according to a modification of Embodiment 1.

### DESCRIPTION OF EMBODIMENTS

The present embodiment will be described below with referring to drawings. In the drawings, the same or equivalent portions are denoted by the same reference sign. In describing the embodiment, explanation of the same or equivalent portions will be appropriately omitted or simplified. Also, in the drawings below, dimensional relationships among constituent members may be different from what they actually are. In describing the embodiment, orientations or positions may be referred to, such as up, down, left, right, front, back, obverse, and reverse. These expressions are employed for descriptive convenience and do not limit disposition, direction, and orientation of a device, a tool, a component, and the like.

### Embodiment 1

### ***Description of Configurations***

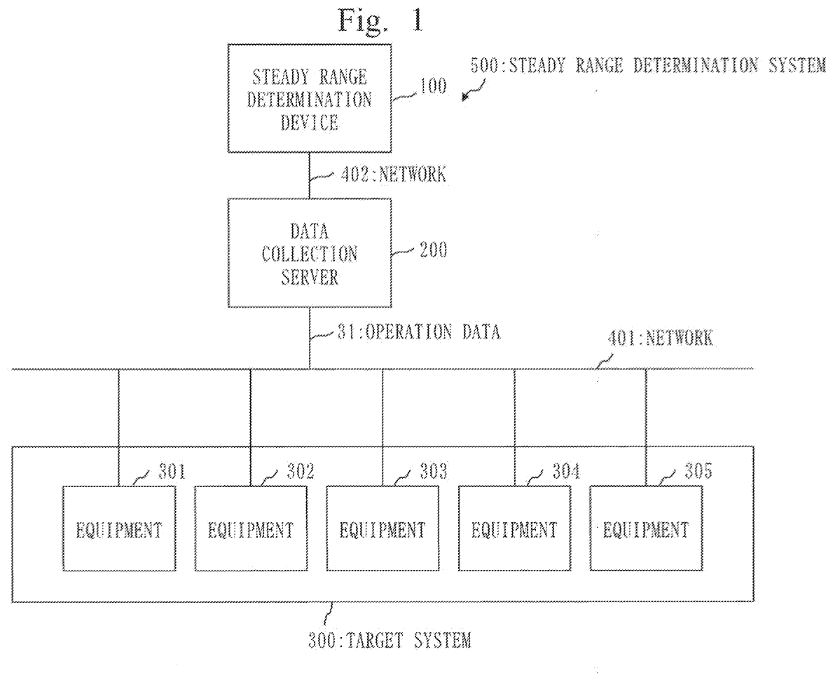

FIG. 1 is a diagram illustrating a configuration example of a steady range determination system 500 according to the present embodiment.

The steady range determination system 500 is provided with a steady range determination device 100, a data collection server 200, and a target system 300.

The steady range determination device 100 monitors the target system 300 such as a factory line. Equipment 301 to equipment 305 exist in the target system 300. In FIG. 1, there are five units of equipment. However, there is no limit to the number of units of equipment. Each equipment is constituted of a plurality of apparatuses such as a sensor and a robot. Each equipment is connected to a network 401, and operation data 31 of the equipment is accumulated in the data collection server 200. The operation data 31 contains a binary signal and a multilevel signal. The binary signal is a signal expressing, for example, ON and OFF of a sensor. The multilevel signal is a signal expressing, for example, a torque value of a robot hand.

The data collection server 200 is connected to the steady range determination device 100 via a network 402.

The steady range determination device 100 determines a steady range of the multilevel signal in the operation data 31 of the equipment. The steady range determination device 100 also detects unsteadiness of the operation data 31. The steady range determination device 100 also displays steadiness or unsteadiness of the operation data 31. The steady range determination device 100 is also called an unsteadiness detection device or an unsteadiness display device.

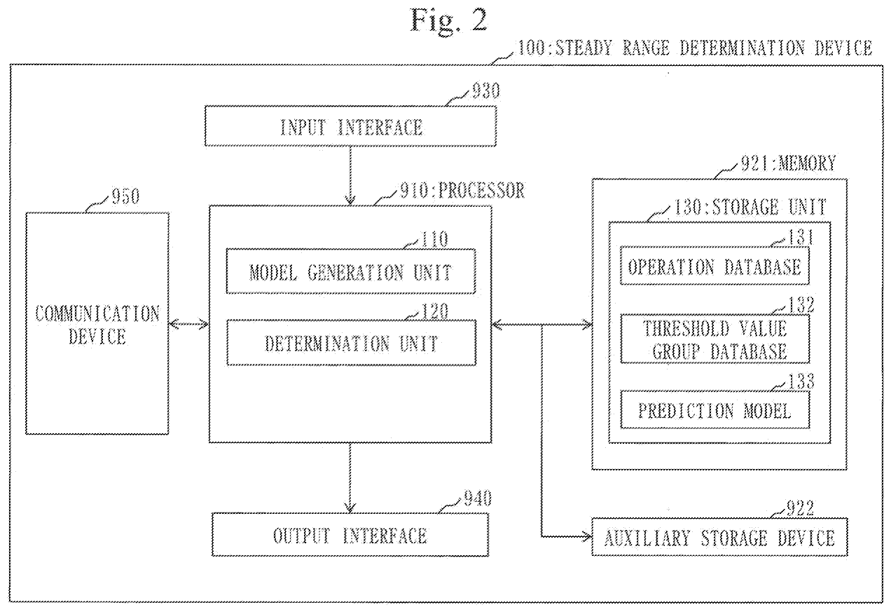

FIG. 2 is a diagram illustrating a configuration example of the steady range determination device 100 according to the present embodiment.

The steady range determination device 100 is a computer. The steady range determination device 100 is provided with a processor 910 and other hardware devices such as a memory 921, an auxiliary storage device 922, an input interface 930, an output interface 940, and a communication device 950. The processor 910 is connected to the other hardware devices via a signal line and controls the other hardware devices.

The steady range determination device 100 is provided with a model generation unit 110, a determination unit 120, and a storage unit 130, as function elements. An operation database 131, a threshold value group database 132, and a prediction model 133 are stored in the storage unit 130.

Functions of the model generation unit 110 and determination unit 120 are implemented by software. The storage unit 130 is provided to the memory 921. The storage unit 130 may be provided to the auxiliary storage device 922, or may be provided to the memory 921 and the auxiliary storage device 922 by distribution.

The processor 910 is a device that runs a steady range determination program. The steady range determination program is a program that implements the functions of the model generation unit 110 and determination unit 120.

The processor 910 is an Integrated Circuit (IC) that performs computation processing. Specific examples of the processor 910 are a Central Processing Unit (CPU), a Digital Signal Processor (DSP), and a Graphics Processing Unit (GPU).

The memory 921 is a storage device that stores data temporarily. A specific example of the memory 921 is a Static Random-Access Memory (SRAM) or a Dynamic Random-Access Memory (DRAM).

The auxiliary storage device 922 is a storage device that keeps data. A specific example of the auxiliary storage device 922 is an HDD. The auxiliary storage device 922 may be a portable storage medium such as an SD (registered trademark) memory card, a CF, a NAND flash, a flexible disk, an optical disk, a compact disk, a Blu-ray (registered trademark) Disc, and a DVD. Note that HDD stands for Hard Disk Drive, SD (registered trademark) stands for Secure Digital, CF stands for CompactFlash (registered trademark), and DVD stands for Digital Versatile Disc.

The input interface 930 is a port to be connected to an input device such as a mouse, a keyboard, and a touch panel. The input interface 930 is specifically a Universal Serial Bus (USB) terminal. The input interface 930 may be a port to be connected to a Local Area Network (LAN).

The output interface 940 is a port to which a cable of a display apparatus such as a display is to be connected. The output interface 940 is specifically a USB terminal or a High Definition Multimedia Interface (HDMI; registered trademark) terminal. The display is specifically a Liquid Crystal Display (LCD). The output interface 940 is also called a display interface.

The communication device 950 has a receiver and a transmitter. The communication device 950 is connected to a communication network such as a LAN, the Internet, and a telephone circuit. The communication device 950 is specifically a communication chip or a Network Interface Card (NIC).

The steady range determination program is run in the steady range determination device 100. The steady range determination program is read by the processor 910 and run by the processor 910. Not only the steady range determination program but also an Operating System (OS) is stored in the memory 921. The processor 910 runs the steady range determination program while running the OS. The steady range determination program and the OS may be stored in the auxiliary storage device 922. The steady range determination program and the OS stored in the auxiliary storage device 922 are loaded to the memory 921 and run by the processor 910. The steady range determination may be incorporated in the OS partly or entirely.

The steady range determination device 100 may be provided with a plurality of processors that substitute for the processor 910. The plurality of processors run the steady range determination program in a shared manner. Each processor is a device that runs the steady range determination program just as the processor 910 does.

Data, information, signal values, and variable values that are utilized, processed, or outputted by the steady range determination program are stored in the memory 921, the auxiliary storage device 922, or a register or cache memory in the processor 910.

The term “unit” in each of the model generation unit 110 and the determination unit 120 may be replaced by “circuit”, “stage”, “procedure”, “process”, or “circuitry”. The steady range determination program causes the computer to execute a model generation process and a determination process. The term “process” in the model generation process and the determination process may be replaced by “program”, “program product”. “program-stored computer readable storage medium”, or “program-recorded computer readable recording medium”. A steady range determination method is a method performed by the steady range determination device 100 running the steady range determination program.

The steady range determination program may be provided in a form of being stored in a computer readable recording medium. The steady range determination program may be provided as a program product.

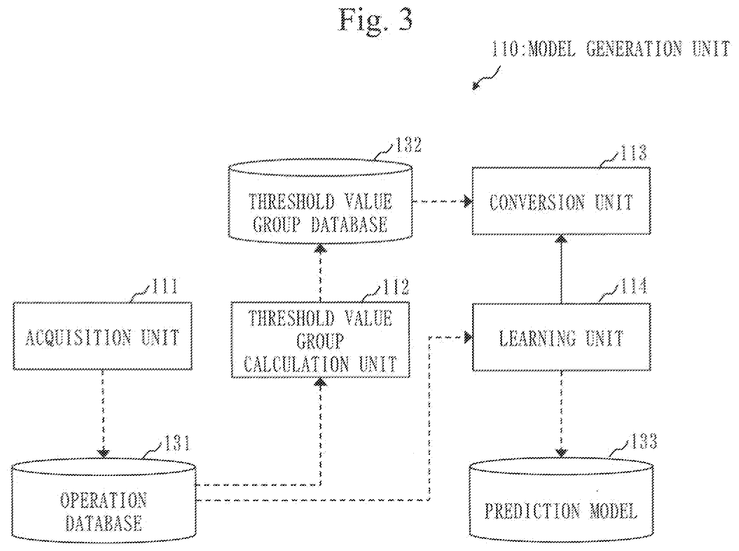

FIG. 3 is a diagram illustrating a functional configuration example of the model generation unit 110 according to the present embodiment.

A solid-line arrow in FIG. 3 expresses a calling relationship between function elements, and broken-line arrows in FIG. 3 express data flows between function elements and the databases.

The model generation unit 110 generates the prediction model 133 for predicting a next signal value of the operation data in normal operation of the equipment. In other words, the model generation unit 110 generates the prediction model 133 for predicting a steady-state signal value of the operation data.

The model generation unit 110 is provided with an acquisition unit 111, a threshold value group calculation unit 112, a conversion unit 113, and a learning unit 114.

The acquisition unit 111 receives, by the communication device 950, the operation data from the data collection server 200, and stores the operation data to the operation database 131. The operation data is, for example, data such as a binary signal expressing ON and OFF of a sensor, or a multilevel signal expressing a torque value of the robot hand. A process of receiving and storing the operation data is executed on necessary data as a target, each time the data increases in the data collection server 200, in real time as much as possible.

The threshold value group calculation unit 112 acquires the operation data from the operation database 131, calculates a threshold value for converting a multilevel signal in the operation data into a binary signal, and stores the threshold value to the threshold value group database 132.

The conversion unit 113 acquires the threshold value from the threshold value group database 132 and converts the multilevel signal into the binary signal on a basis of the threshold value.

The learning unit 114 acquires the operation data from the operation database 131 and calls the conversion unit 113 to convert, with the conversion unit 113, the multilevel signal in the acquired operation data into the binary signal. The learning unit 114 learns a normal signal pattern of the signal contained in the operation data, from the binary signal contained in the operation data and the binary signal converted by the conversion unit 113 from the multilevel signal contained in the operation data. After that, the learning unit 114 saves a learned model that predicts the learned normal signal pattern, as the prediction model 133.

The threshold value group calculation unit 112 sets the threshold value such that, for example, the signal value of the multilevel signal is converted into a binary signal that switches over when a tendency of the value such as increasing, decreasing, and staying constant changes. The threshold value for converting the multilevel signal into the binary signal can be set to an arbitrary value, and an arbitrary number of threshold values can be set. Note that there is no limitation as to how to calculate the threshold value.

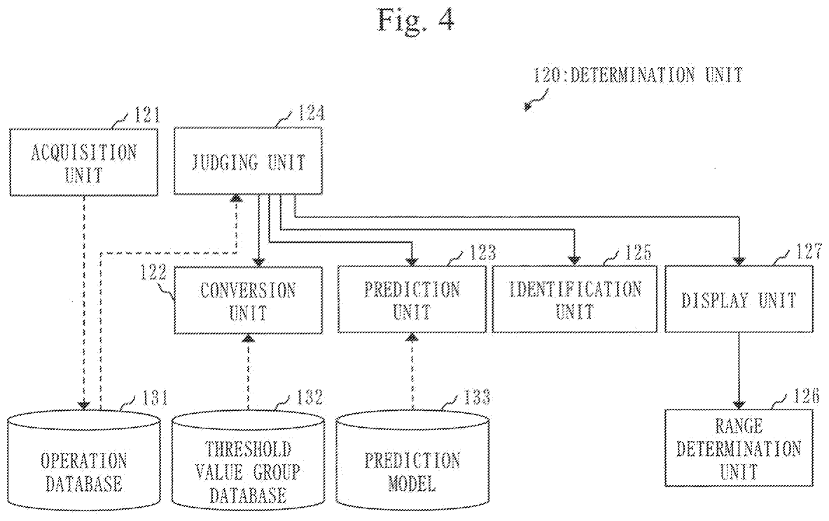

FIG. 4 is a diagram illustrating a functional configuration example of the determination unit 120 according to the present embodiment.

Solid-line arrows in FIG. 4 express calling relationships between function elements, and broken-line arrows express data flows between function elements and the databases.

The determination unit 120 predicts a next signal value of a signal in normal operation from the operation data, judges whether the next signal value is unsteady or not, identifies an unsteady portion, and determines a steady range and displays the steady range along with the operation data.

The determination unit 120 is provided with an acquisition unit 121, a conversion unit 122, a prediction unit 123, a judging unit 124, an identification unit 125, a range determination unit 126, and a display unit 127.

Just as the acquisition unit 111 in the model generation unit 110 does, the acquisition unit 121 receives the operation data from the data collection server 200 by the communication device 950, and stores the operation data to the operation database 131.

Just as the conversion unit 113 in the model generation unit 110 does, the conversion unit 122 acquires the threshold value from the threshold value group database 132, and converts the multilevel signal into a binary signal on a basis of the threshold value.

Regarding the operation data being a binary signal and the binary signal converted by the conversion unit 122, the prediction unit 123 calculates, using the prediction model 133, prediction values being steady values of a signal value to be outputted next. All inputs to the prediction model 133 are binary signals. In the following, the binary signal converted from the multilevel signal in the operation data by the conversion unit 122, that is, the binary signal outputted by the conversion unit 122, may be called a converted binary signal.

Note that the judging unit 124 acquires the operation data from the operation database 131 and calls the conversion unit 122 and the prediction unit 123 so that a conversion process by the conversion unit 122 and a prediction process by the prediction unit 123 are executed.

The judging unit 124 compares the binary signal in the operation data and an actual measurement value of the converted binary signal with the prediction values outputted from the prediction unit 123. From the comparison result, the judging unit 124 judges whether the operation data is steady or not, that is, whether the operation data coincides with the learned normal signal pattern. The judging unit 124 outputs a judgment result as unsteadiness judgment information. If it is judged that the operation data is unsteady, the judging unit 124 calls the identification unit 125 and identifies an unsteady portion with the identification unit 125. The judging unit 124 also calls the display unit 127 and displays the judgment result on the display apparatus by the display unit 127.

The identification unit 125 identifies which signal was unsteady and when it was unsteady, based on the binary signal in the operation data and the converted binary signal, and based on the prediction value of the binary signal and the prediction value of the converted binary signal. The identification unit 125 outputs identified information as unsteadiness identification information.

The range determination unit 126 determines a steady range of the signal value in the multilevel signal as before conversion into the converted binary signal, based on the prediction value of the converted binary signal.

The display unit 127 may determine the unsteady range in the multilevel signal by calling the range determination unit 126.

Using the steady range in the multilevel signal, the display unit 127 visibly displays information such as the actual measurement value of the operation data, the prediction values outputted from the prediction unit 123, unsteadiness judging information outputted from the judging unit 124, and unsteadiness identification information outputted from the identification unit 125, onto the display apparatus such that they can be recognized easily.

***Description of Operations***

Operations of the steady range determination system 500 according to the present embodiment will now be described. An operation procedure of the steady range determination system 500 corresponds to the steady range determination method. A program that implements the operations of the steady range determination system 500 corresponds to the steady range determination program that causes the computer to execute a steady range determination process. The operations of the steady range determination system 500 are operations of the individual devices of the steady range determination system 500.

<Steady Range Determination Process>

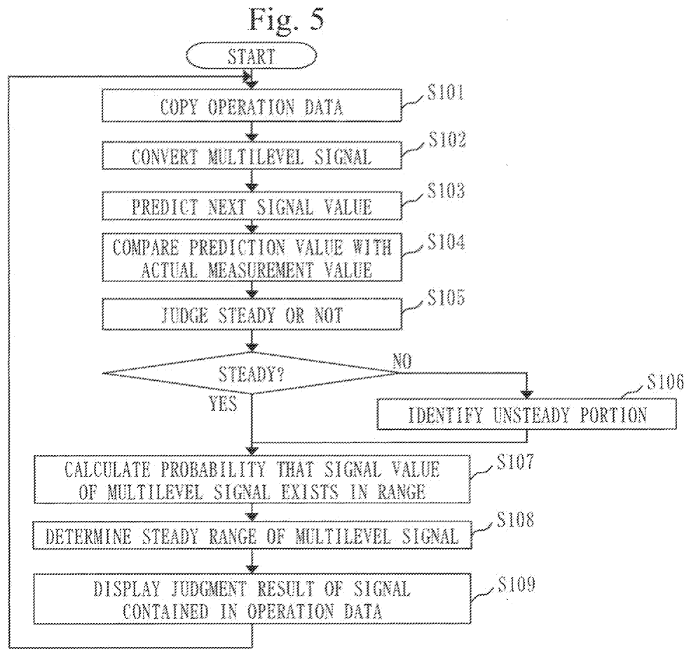

FIG. 5 is an overall flowchart of a steady range determination process by the steady range determination device 100 according to the present embodiment.

Referring to FIG. 5, details of step S107 “a calculation process of an existence probability of a signal value of a multilevel signal” and step S108 “a determination process of a steady range of the signal value of the multilevel signal” will be described later.

<<Acquisition Process>>

In step S101, the acquisition unit 121 copies the operation data from the data collection server 200 to the operation database 131 via the communication device 950. For example, when the operation data outputted from the data collection server 200 contains a binary signal expressing ON and OFF of a sensor and a multilevel signal expressing a torque value of a robot hand, both of the binary signal and the multilevel signal are stored in the operation database 131 as the operation data.

In the prediction process by the prediction unit 123, operation data covering a past fixed period of time is required. Hence, operation data covering the past fixed period of time required for the prediction process is held in the operation database 131.

Note that the acquisition unit 121 copies the operation data from the data collection server 200 to the operation database 131 in real time as much as possible.

<<Conversion Process>>

In step S102, the conversion unit 122 converts, out of the operation data stored in the operation database 131, signal data of the multilevel signal into signal data of the binary signal. The conversion unit 122 sets at least one threshold value for the multilevel signal contained in the operation data, and converts the multilevel signal into at least one binary signal with using the threshold value.

Specifically, the conversion unit 122 acquires the threshold value from the threshold value group database 132. On the basis of the threshold value, the conversion unit 122 converts, out of the operation data stored in the operation database 131, the signal data of the multilevel signal into the signal data of the binary signal. Details of the conversion process will be described later.

<<Prediction Process>>

In step S103, the prediction unit 123 predicts next signal values from the past binary signal held in the operation database 131 and from the converted binary signal converted from the past multilevel signal held by the operation database 131. For the prediction, the prediction model 133 generated by the model generation unit 110 in advance is utilized.

The prediction unit 123 inputs the binary signal originally contained in the operation data, and the converted binary signal to the prediction model 133, and outputs prediction values being steady-state signal values of the signal contained in the operation data. Particularly, regarding the binary signal (converted binary signal) converted by the conversion unit 122, the prediction unit 123 inputs the converted binary signal to the prediction model 133 and outputs a prediction value of the converted binary signal as a converted binary signal prediction value.

<<Judging Process>>

In step S104, the judging unit 124 compares the prediction value, calculated in step S103, of the operation data with the actual measurement value of the signal of the operation data stored in the operation database 131, and calculates an abnormality degree.

In step S105, the judging unit 124 judges whether the operation data is steady or unsteady on a basis of the abnormality degree calculated in step S104.

If it is determined that the operation data is not steady, the judging unit 124 proceeds to step S106. If it is determined that the operation data is steady, the judging unit 124 proceeds to step S107.

<<Range Determination Process>>

In step S106, the identification unit 125 identifies which signal was unsteady and when it was unsteady. Specifically, the identification unit 125 can identify an unsteady portion by extracting a signal whose prediction value and actual measurement value were different from each other by a fixed value or more and by extracting a time point at which the difference occurred.

<<Range Determination Process>>

Referring to step S107 and step S108, a range determination process by the range determination unit 126 will now be described.

In step S107, the range determination unit 126 calculates, from the prediction value of the signal of the operation data calculated in step S103, a probability that the signal value of the multilevel signal exists in the range. Specifically, the range determination unit 126 calculates, based on the converted binary signal prediction value and the threshold value, a probability that the signal value of the multilevel signal contained in the operation data exists in a range determined based on the threshold value.

The converted binary signal prediction value is the prediction value of the converted binary signal obtained by inputting the binary signal converted by the conversion unit 122 to the prediction model 133. The threshold value is that threshold value employed when converting the multilevel signal into the binary signal.

In step S108, the range determination unit 126 determines the steady range of the multilevel signal contained in the operation data, on a basis of the probability calculated in step S107 that the signal value of the multilevel signal exists in the range.

In step S109, the display unit 127 presents to the user a judgment result of the binary signal or multilevel signal contained in the operation data. In the example of the present embodiment, the judgment result is presented to the user by displaying on the display apparatus. Alternatively, the judgment result may be presented to the user by another method such as outputting the judgment result to the printer or outputting the result as electronic data.

The display unit 127 shows behavior of the signal in a time-series manner. If the signal is a binary signal, the display unit 127 shows a prediction value of the binary signal expressing normal behavior.

In the case of a multilevel signal, the display unit 127 displays the signal value of the multilevel signal by superposing over the range including the steady range and determined based on the threshold value. For example, the display unit 127 may display a background of the steady range determined in step S108 in a first color (for example, green), may display the background diverging from the steady range in a second color (for example, yellow) or a third color (for example, red), according to a diverging degree from the steady range, and may superpose the signal value of the multilevel signal. Furthermore, the display unit 127 may display a line indicating the signal value diverging from the steady range in a second color (for example, yellow) or a third color (for example, red), according to the diverging degree.

Each process will be described in detail.

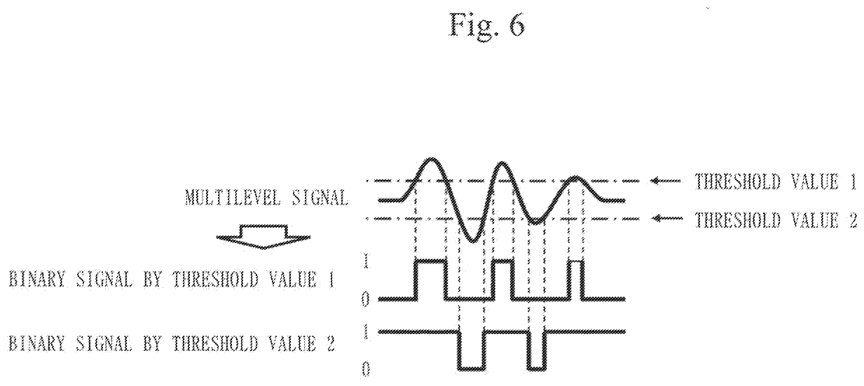

FIG. 6 is a diagram illustrating a specific example of the conversion process according to the present embodiment.

The conversion unit 122 converts the multilevel signal into at least one binary signal with using at least one threshold value. The multilevel signal need not always be converted into the binary signal with using a plurality of threshold values. The multilevel signal is converted into binary signals as many as a number of threshold values. When two threshold values are set for the multilevel value as in FIG. 6, the multilevel signal is converted into two binary signals.

Specifically, the conversion unit 122 converts the multilevel signal into a binary signal that takes 1 if the signal value of the multilevel signal at each time point exceeds the threshold value; and takes 0 otherwise.

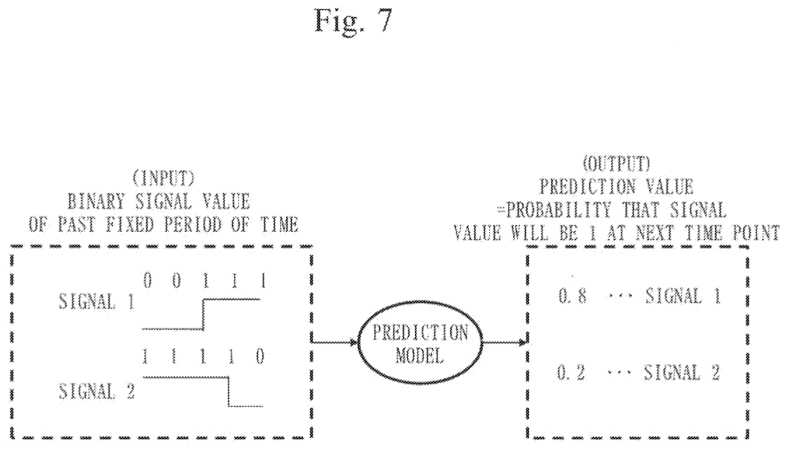

FIG. 7 is a diagram illustrating an example of input/output of the prediction model 133 according to the present embodiment.

The prediction model 133 learns a signal pattern of a normal binary signal and outputs a prediction value of the signal. The prediction value is a real number value of 0 or more to 1 or less, as illustrated in FIG. 7, and corresponds to a probability that the signal value becomes 1 at the next time point. The output does not have a change-over-time pattern of the binary signal but expresses a prediction value of each binary signal of only one next time point.

Assume that as past signal data, signal 1 takes values 0, 0, 1, 1, 1 and signal 2 takes values 1, 1, 1, 1, 0. When these values are inputted to the prediction model, a value of 0.8 is outputted as a prediction value of the signal 1, and a value of 0.2 is outputted as a prediction value of the signal 2. This means that at this time, the probability that the value of the signal 1 will be 1 at the next time point is 0.8, and the probability that the value of the signal 2 will be 1 at the next time point is 0.2.

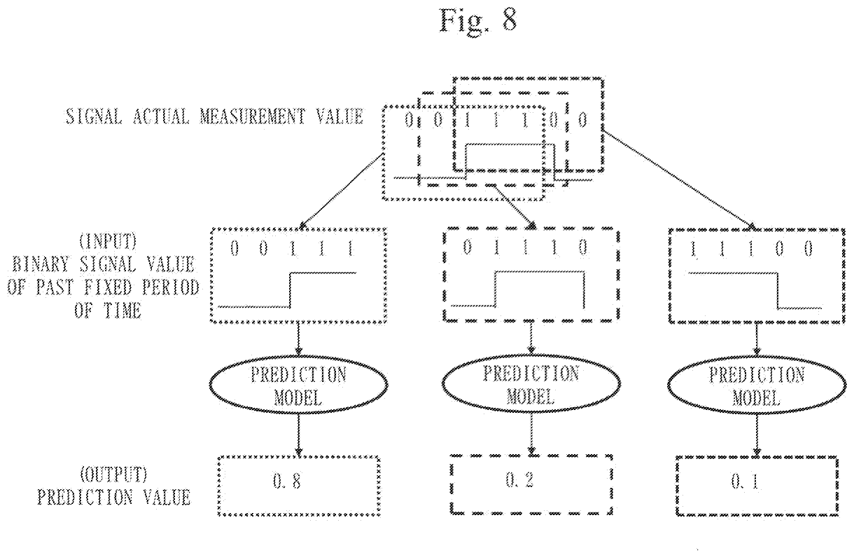

FIG. 8 is a diagram illustrating an example in which prediction values of one signal are outputted in a time-series manner in the prediction process according to the present embodiment.

In FIG. 8, prediction is performed repeatedly, and prediction values of individual time points are placed in a time-series manner. Note that for the sake of convenience, in FIG. 8, input/output is one signal, that is, a binary signal obtained from one threshold value.

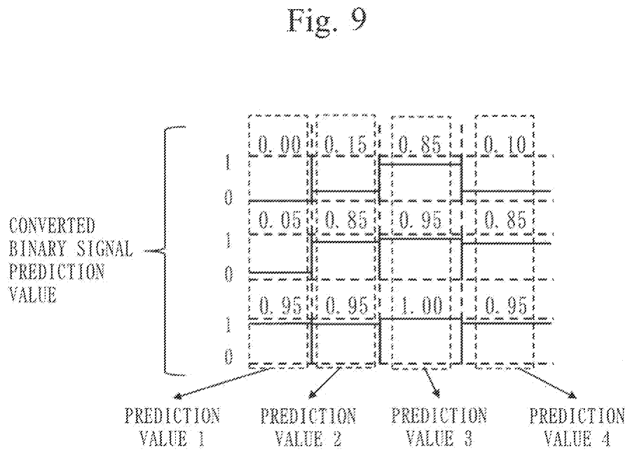

FIG. 9 is a diagram illustrating an example in which prediction values in three signals are outputted in a time-series manner in the prediction process according to the present embodiment.

In FIG. 9, prediction values about three signals are placed in a time-series manner. A plurality of signal values of the same time point are outputted all together at one time from the prediction model. That is, prediction value 1 to prediction value 4 in FIG. 9 are outputted all together at once from the prediction model.

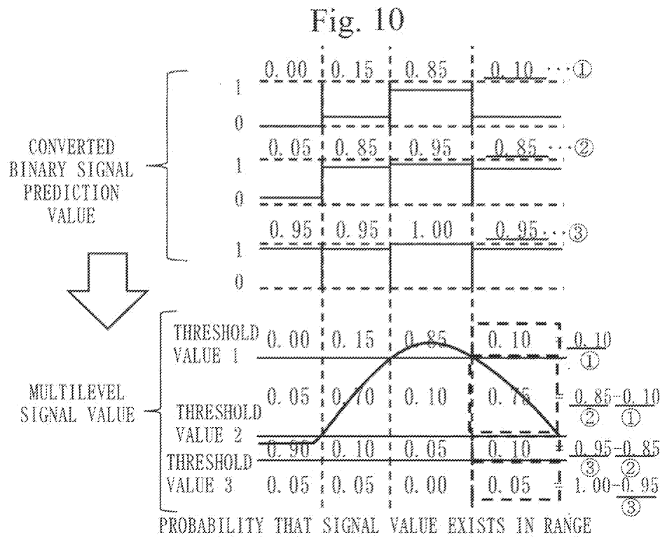

FIG. 10 is a diagram illustrating an example of calculating a probability that the signal value of the multilevel signal according to the present embodiment exists in the range.

As described above, the prediction value outputted by the prediction unit 123 is a real number value of 0 or more to 1 or less, and corresponds to the probability that the signal value becomes 1 at each time point. Hence, the prediction value of the binary signal converted from the multilevel signal to become 1 if the signal value exceeds a threshold value and to become 0 otherwise corresponds to the probability that the signal value exceeds that threshold value. A probability that the signal value exists in a range between two threshold values is obtained by the following formula (1).

(A probability that the signal value exists in a range between two threshold values)=(a probability that the signal value exceeds a lower-side threshold value)−(a probability that the signal value exceeds an upper-side threshold value) <Formula (1)>

A probability that the signal value exists in a range above a maximum threshold value and a probability that the signal value exists in a range below a minimum threshold value are obtained by formula (2) and formula (3), respectively.

(A probability that the signal value exists in a range above a maximum threshold value)=(a probability that the signal value exceeds the maximum threshold value) <Formula (2)>

(A probability that the signal value exists in a range below a minimum threshold value)=1−(a probability that the signal value exceeds a minimum threshold value) <Formula (3)>

As described above, the probability that the signal value of the multilevel signal exists in the range is calculated from the prediction value of the binary signal converted by setting a threshold value for the multilevel signal. The probability will be a real number value of 0 or more to 1 or less.

In the conversion unit 122, a plurality of threshold values may be set for the multilevel signal, and the multilevel signal may be converted into a binary signal that takes 1 if the signal value exceeds a threshold value and takes 0 otherwise. In that case, the prediction value of the binary signal corresponds to a probability that a signal value at each time point falls below the threshold value. A probability that the signal value exists in a range between two threshold values, a probability that the signal value exists in a range above a maximum threshold value, and a probability that the signal value exists in a range below a minimum threshold value are obtained from formula (4), formula (5), and formula (6), respectively.

(A probability that the signal value exists in a range between two threshold values)=(a probability that the signal value falls below an upper-side threshold value)−(a probability that the signal value falls belowa lower-side threshold value) <Formula (4)>

(A probability that the signal value exists in a range above a maximum threshold value)=1−(a probability that the signal value falls below the maximum threshold value) <Formula (5)>

(A probability that the signal value exists in a range below a minimum threshold value)=(a probability that the signal value falls below a minimum threshold value) <Formula (6)>

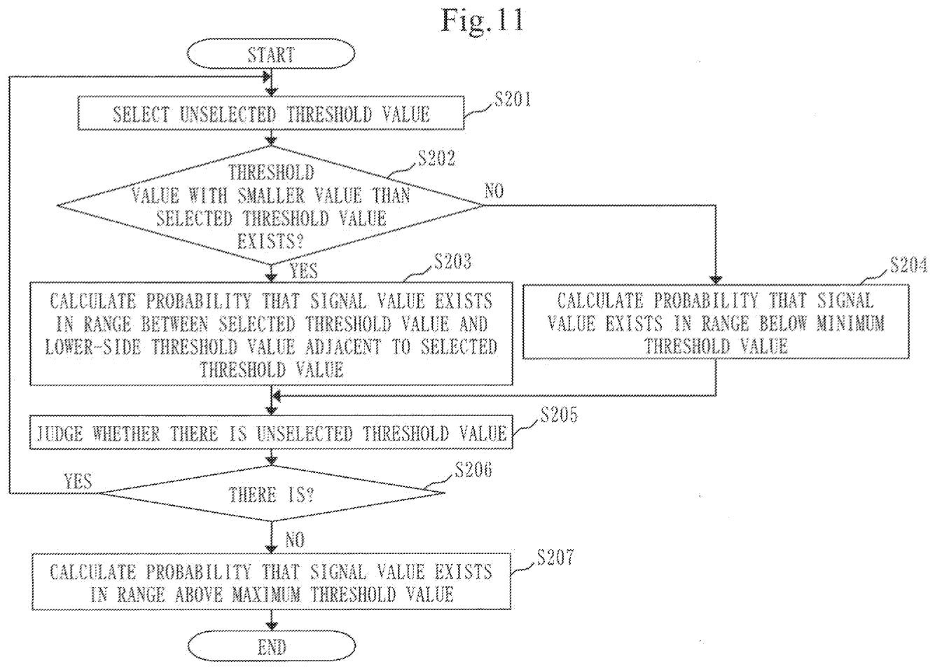

FIG. 11 is a detailed flowchart of a process of calculating an in-range probability of the signal value of the multilevel signal according to the present embodiment.

In step S201, the range determination unit 126 selects one unselected threshold value from the plurality of threshold values employed when converting the multilevel signal into the binary signal.

In step S202, the range determination unit 126 judges whether or not a threshold value with a smaller value than the selected threshold value exists. If such threshold value exists, the range determination unit 126 proceeds to step S203. If such threshold value does not exist, the range determination unit 126 proceeds to step S204.

If a threshold value with a smaller value than the selected threshold value exists, then in step S203, the range determination unit 126 calculates a probability that the signal value exists in a range between the selected threshold value and a lower-side threshold value adjacent to the selected threshold value.

If a threshold value with a smaller value than the selected threshold value does not exist, then in step S204, the range determination unit 126 calculates a probability that the signal value exists in a range below the minimum threshold value.

In step S205 and step S206, the range determination unit 126 judges whether there is an unselected threshold value. If there is an unselected threshold value, the range determination unit 126 returns to step S201 and repeats the processing until there is no unselected threshold value.

If there is no unselected threshold value, then in step S207, the range determination unit 126 calculates a probability that the signal value exists in a range above the maximum threshold value.

The method of determining a steady range of the multilevel signal will now be described.

<First Determination Method of Steady Range Determination Process>

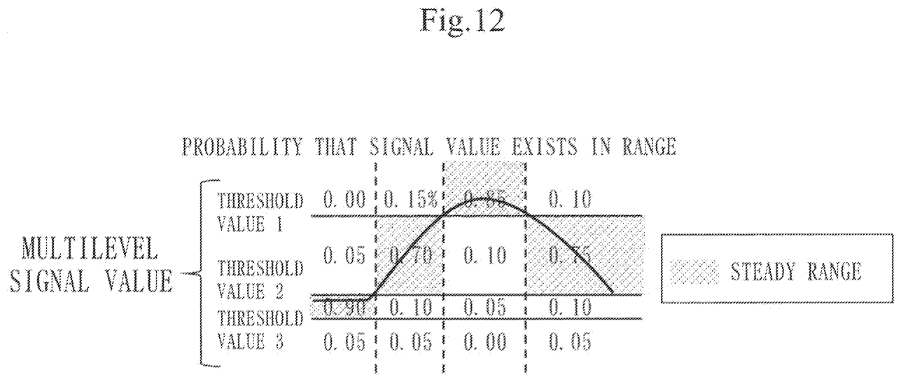

FIG. 12 is a diagram illustrating a specific example of a first determination method of the steady range determination process according to the present embodiment.

According to the first determination method, the range determination unit 126 determines, from among ranges each determined based on the threshold value, a range where the probability has a determined value or more, as the steady range. The determined value is a fixed value determined in advance.

Specifically, the range determination unit 126 takes a range where the probability of the signal value at the same point has a fixed value or more, as the steady range. FIG. 12 illustrates an example in which a range where the probability is 0.5 or more is determined as the steady range.

<Second Determination Method of Steady Range Determination Process>

According to the second determination method, the range determination unit 126 determines, from among ranges each determined based on the threshold value, a range where the probability is maximum, as the steady range.

Specifically, the range determination unit 126 takes a range where the probability of the signal value at the same point is maximum, as the steady range.

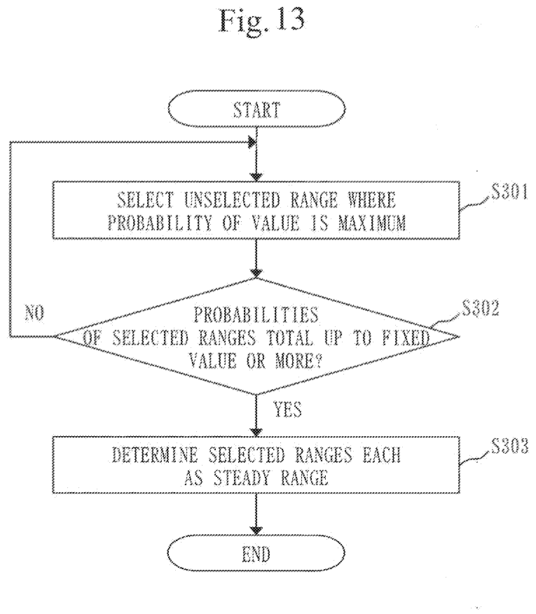

FIG. 13 is a flowchart illustrating an example of the second determination method of the steady range determination process according to the present embodiment.

FIG. 13 illustrates a determination method according to probability descending-order range selection.

With the determination method according to probability descending-order range selection, the range determination unit 126 selects, from among ranges each determined based on the threshold value, ranges in a descending order of probability, and determines ranges selected until the probabilities total up to a determined value or more, each as the steady range.

Specifically, the range determination unit 126 selects ranges in a descending order of the probability of the same time point, and takes ranges selected until the probabilities total up to a fixed value or more, each as the steady range.

In step S301, the range determination unit 126 selects an unselected range where the probability of the value is maximum.

In step S302, the range determination unit 126 repeats step S301 until the probabilities of the selected ranges total up to the fixed value or more.

In step S303, when the probabilities of the selected ranges total up to the fixed value or more, the range determination unit 126 determines the selected ranges, each as the steady range.

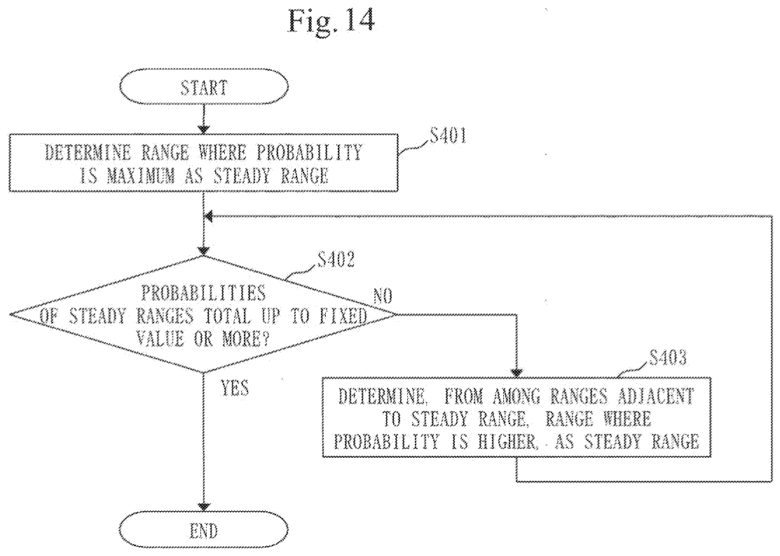

FIG. 14 is a flowchart illustrating another example of the second determination method of the steady range determination process according to the present embodiment.

FIG. 14 illustrates a determination method according to adjacent maximum probability range selection.

With the determination method according to adjacent maximum probability range selection, the range determination unit 126 repeats selecting, from among ranges each determined based on the threshold value, a range where the probability is maximum and selecting, from among ranges adjacent to the selected range, a range where the probability is larger. The range determination unit 126 determines ranges selected until the probabilities of the selected ranges total up to a determined value or more, each as the steady range.

Specifically, the range determination unit 126 repeats selecting a range where the probability of the same time point is maximum and selecting, from among ranges adjacent to the selected range, a range where the probability is larger; and takes ranges selected until the probabilities total up to a fixed value or more, as the steady range.

In step S401, the range determination unit 126 determines a range where the probability of the value is maximum, each as the steady range.

In step S402, if probabilities of the steady ranges do not total up to or the fixed value or more, the range determination unit 126 proceeds to step S403. If the probabilities of the steady ranges total up to the fixed value or more, the range determination unit 126 ends the processing.

In step S403, the range determination unit 126 determines, from among ranges adjacent to the steady range, a range where the probability is higher, as the steady range. The range determination unit 126 repeats step S402 and step S403 until the probabilities of the steady ranges total up to the fixed value or more.

<Third Determination Method of Steady Range Determination Process>

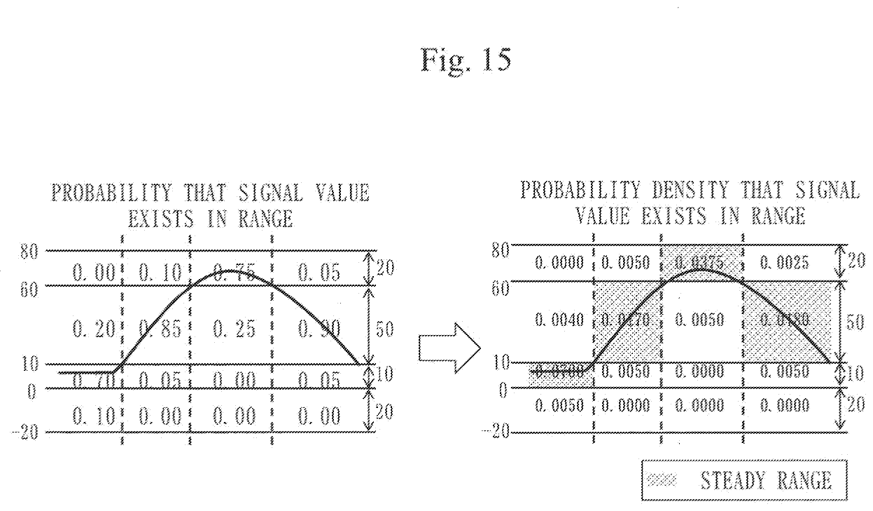

FIG. 15 is a diagram illustrating a specific example of a third determination method of the steady range determination process according to the present embodiment.

According to the third method, the range determination unit 126 determines, from among ranges each determined based on the threshold value, a range where a probability density being a value obtained by dividing the probability by a width of the range has a determined value or more, as the steady range.

Specifically, the range determination unit 126 takes a range where a probability density of the signal value of the same time point has a fixed value or more, as the steady range. FIG. 15 illustrates a case where probability densities are calculated and ranges where the probability densities are 0,0100 or more are determined as the steady range.

When determining the steady range, the larger the width of the range, the higher the probability of the value would be. In view of this, the steady range is determined based on the probability density, so that it is possible to highly evaluate a steadiness degree of a range having a small width and accordingly a small probability.

<Fourth Determination Method of Steady Range Determination Process>

In the fourth determination method, variations of the determination method that employs the probability density will be described.

The range determination unit 126 may determine, from among ranges each determined based on the threshold value, a range where the probability is maximum, as the steady range.

Specifically, the range determination unit 126 takes a range where the probability density of the same time point is maximum, as the steady range.

Alternatively, the range determination unit 126 may select, from among ranges each determined based on the threshold values, ranges in a descending order of probability density, and may determine ranges selected until the probability densities total up to a determined value or more, each as the steady range.

Specifically, the range determination unit 126 selects a range in a descending order of the probability of the same time point, and takes ranges selected until the probability densities total up to a fixed value or more, each as the steady range.

Alternatively, the range determination unit 126 repeats selecting, from among ranges each determined based on the threshold value, a range where the probability density is maximum and selecting, from among ranges adjacent to the selected range, a range where the probability density is larger. The range determination unit 126 may then determine ranges selected until the probability densities total up to a determined value or more, each as the steady range.

Specifically, the range determination unit 126 repeats selecting a range where the probability density of the same time point is maximum and selecting, from among ranges adjacent to the selected range, a range where the probability density is larger; and takes ranges selected until the probability densities total up to a fixed value or more, each as the steady range.

<Fifth Determination Method of Steady Range Determination Process>

In a fifth determination method of the steady range determination process, when determining a steady range of a multilevel signal, the range determination unit 126 may determine an unsteady range stepwise.

In a first unsteady range stepwise determination method, the range determination unit 126 determines, regarding the ranges each determined based on the threshold value, an unsteadiness degree of a range that is not steady, according to the probability.

Specifically, the range determination unit 126 determines the unsteadiness degree of the range according to the probability of the value of the same time point. For example, if a range where the probability is 0.5 or more is determined as steady, a range where the probability is 0.2 or more to less than 0.5 is determined as lightly unsteady, and a range where the probability is less than 0.2 is determined as seriously unsteady. Three or more levels of unsteadiness degree may be defined.

The range determination unit 126 may determine, regarding the ranges each determined based on the threshold value, an unsteadiness degree of a range that is not steady, according to the probability density, instead of according to the probability.

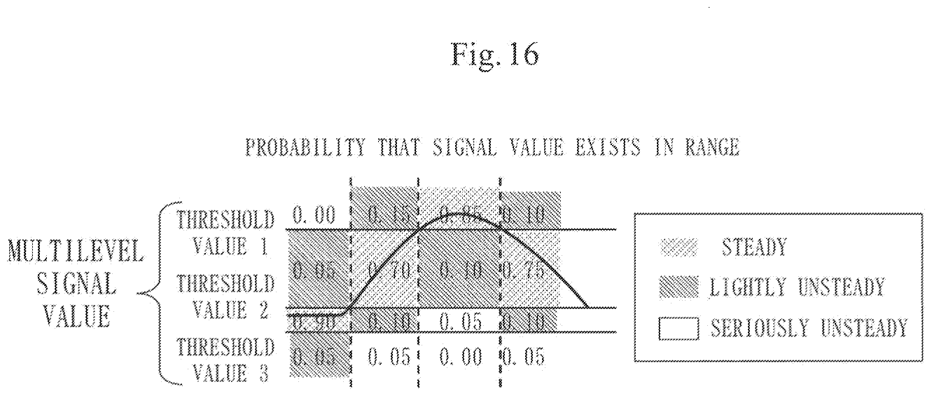

FIG. 16 is a diagram illustrating a specific example of a second unsteady range stepwise determination method of the steady range determination process according to the present embodiment.

FIG. 16 illustrates an example of steady range stepwise determination according to a separation degree from the steady range.

According to the second unsteady range stepwise determination method, the range determination unit 126 determines, regarding the ranges each determined based on the threshold value, an unsteadiness degree of a range that is not steady, according to the separation degree from the steady range.

In FIG. 16, the range determination unit 126 determines the unsteadiness degree by the separation degree of the range from the steady range. A range adjacent to the steady range is determined as lightly unsteady, and a range separate from the steady range by two or more ranges is determined as seriously unsteady.

### Other Configurations

In the present embodiment, the functions of the model generation unit 110 and determination unit 120 are implemented by software. In a modification, the functions of the model generation unit 110 and determination unit 120 may be implemented by hardware.

Specifically, a steady range determination device 100 is provided with an electronic circuit 909 in place of a processor 910.

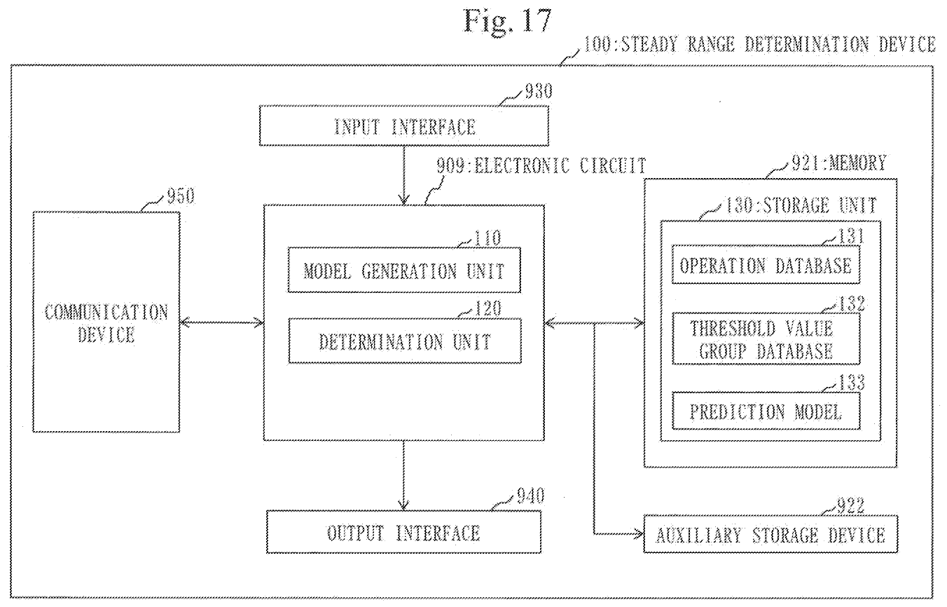

FIG. 17 is a diagram illustrating a configuration example of the steady range determination device 100 according to the modification of the present embodiment. The electronic circuit 909 is a dedicated electronic circuit that implements the functions of the model generation unit 110 and determination unit 120. The electronic circuit 909 is specifically a single circuit, a composite circuit, a programmed processor, a parallel-programmed processor, a logic IC, a GA, an ASIC, or an FPGA. Note that GA stands for Gate Array, ASIC stands for Application Specific Integrated Circuit, and FPGA stands for Field-Programmable Gate Array.

The functions of the model generation unit 110 and determination unit 120 may be implemented by one electronic circuit, or may be implemented by a plurality of electronic circuits by distribution.

According to another modification, some of the functions of the model generation unit 110 and determination unit 120 may be implemented by an electronic circuit, and the remaining functions may be implemented by software. Some or all of the functions of the model generation unit 110 and determination unit 120 may be implemented by firmware.

The processor and the electronic circuit are also called processing circuitry. That is, the functions of the model generation unit 110 and determination unit 120 are implemented by processing circuitry.

### Description of Effect of Present Embodiment

As described above, with the steady range determination device 100 according to the present embodiment, a steady range of a signal value of a multilevel signal is calculated on a basis of a probability that the signal value of the multilevel signal exists between two threshold values. Hence, with the steady range determination device 100 according to the present embodiment, it is possible to clearly show to the operator how the signal value of the multilevel signal differs as compared with the steady range.

Also, with the steady range determination device 100 according to the present embodiment, it is possible to calculate the steady range of the signal value of the multilevel signal on a basis of the probability density in the range.

It is assumed that the probability that the signal value of the multilevel signal exists in the range will increase as the range width increases. Therefore, with the steady range determination device 100 according to the present embodiment, the steady range is determined based on the probability density, so that it is possible to appropriately evaluate the steadiness degree of a range having a small width and accordingly a small probability.

In Embodiment 1 above, each unit in the steady range determination device is described as an independent function block. However, the steady range determination device need not have a configuration as that of the embodiment described above. The function block of the steady range determination device may have any configuration as far as it can implement the function described in the above embodiment. Also, the steady range determination device need not be constituted of one device but may be a system constituted of a plurality of devices.

A plurality of portions of Embodiment 1 may be practiced by combination. Alternatively, one portion of this embodiment may be practiced. Also, this embodiment may be practiced entirely, or may be practiced partly by any combination.

That is, in Embodiment 1, different embodiments may be combined freely, an arbitrary constituent element of each embodiment may be modified, or an arbitrary constituent element may be omitted in each embodiment.

The embodiment described above is an essentially preferred exemplification, and is not intended to limit the scope of the present disclosure, the scope of an applied product of the present disclosure, and a scope of usage of the present disclosure. The embodiment described above can be changed in various manners as necessary.

### REFERENCE SIGNS LIST

31: operation data; 100: steady range determination device; 110: model generation unit; 111, 121: acquisition unit; 112: threshold value group calculation unit; 113, 122: conversion unit; 114: learning unit; 120: determination unit; 123: prediction unit; 124: judging unit; 125: identification unit; 126: range determination unit; 127: display unit; 130: storage unit; 131: operation database; 132: threshold value group database; 133: prediction model; 200: data collection server; 300: target system; 301, 302, 303, 304, 305: equipment; 401, 402: network; 500: steady range determination system; 909: electronic circuit; 910: processor; 921: memory; 922: auxiliary storage device; 930: input interface; 940: output interface; 950: communication device.

1. A steady range determination system which determines a steady range of a multilevel signal in operation data containing the multilevel signal, the steady range determination system comprising
processing circuitry
to set at least one threshold value for the multilevel signal contained in the operation data, and to convert the multilevel signal into at least one binary signal with using the threshold value,
to input the converted binary signal to a prediction model which predicts a steady-state signal value of the operation data, and to calculate a prediction value of the converted binary signal as a converted binary signal prediction value, and
to calculate, based on the converted binary signal prediction value and the threshold value, a probability that a signal value of the multilevel signal contained in the operation data exists in a range determined based on the threshold value, and to determine the steady range of the multilevel signal contained in the operation data, on a basis of the probability.

2. The steady range determination system according to claim 1,
wherein the processing circuitry displays the signal value of the multilevel signal contained in the operation data by superposing over the range including the steady range and determined based on the threshold value.

3. The steady range determination system according to claim 1,
wherein the processing circuitry determines, from among ranges each determined based on the threshold value, a range where the probability has a determined value or more, as the steady range.

4. The steady range determination system according to claim 1,
wherein the processing circuitry determines, from among ranges each determined based on the threshold value, a range where the probability is maximum, as the steady range.

5. The steady range determination system according to claim 4,
wherein the processing circuitry selects, from among ranges each determined based on the threshold value, ranges in a descending order of probability, and determines ranges selected until the probabilities total up to a determined value or more, each as the steady range.

6. The steady range determination system according to claim 4,
wherein the processing circuitry repeats selecting, from among ranges each determined based on the threshold value, a range where the probability is maximum and selecting, from among ranges adjacent to the selected range, a range where the probability is larger; and determines ranges selected until the probabilities total up to a determined value or more, each as the steady range.

7. The steady range determination system according to claim 1,
wherein the processing circuitry determines, from among ranges each determined based on the threshold value, a range where a probability density being a value obtained by dividing the probability by a width of the range has a determined value or more, as the steady range.

8. The steady range determination system according to claim 1,
wherein the processing circuitry determines, from among ranges each determined based on the threshold value, a range where a probability density being a value obtained by dividing the probability by a width of the range is maximum, as the steady range.

9. The steady range determination system according to claim 8,
wherein the processing circuitry selects, from among ranges each determined based on the threshold value, ranges in a descending order of probability density being a value obtained by dividing the probability by a width of the range, and determines ranges selected until the probability densities total up to a determined value or more, each as the steady range.

10. The steady range determination system according to claim 8,
wherein the processing circuitry repeats selecting, from among ranges each determined based on the threshold value, a range where a probability density being a value obtained by dividing the probability by a width of the range is maximum and selecting, from among ranges adjacent to the selected range, a range where the probability density is larger; and determines ranges selected until the probabilities total up to a determined value or more, each as the steady range.

11. The steady range determination system according to claim 3,
wherein the processing circuitry determines, regarding the ranges each determined based on the threshold value, an unsteadiness degree of a range that is not steady, according to the probability.

12. The steady range determination system according to claim 7,
wherein the processing circuitry determines, regarding the ranges each determined based on the threshold value, an unsteadiness degree of a range that is not steady, according to the probability density being the value obtained by dividing the probability by the width of the range.

13. The steady range determination system according to claim 1,
wherein the processing circuitry determines, regarding the ranges each determined based on the threshold value, an unsteadiness degree of a range that is not steady, according to a separation degree from the steady range.

14. A steady range determination method employed in a steady range determination system which determines a steady range of a multilevel signal in operation data containing the multilevel signal, the steady range determination method comprising:
setting at least one threshold value for the multilevel signal contained in the operation data, and converting the multilevel signal into at least one binary signal with using the threshold value;
inputting the converted binary signal to a prediction model which predicts a steady-state signal value of the operation data, and calculating a prediction value of the converted binary signal as a converted binary signal prediction value; and
calculating, based on the converted binary signal prediction value and the threshold value, a probability that a signal value of the multilevel signal contained in the operation data exists in a range determined based on the threshold value, and determining the steady range of the multilevel signal contained in the operation data, on a basis of the probability.

15. A non-transitory computer readable medium storing a steady range determination program employed in a steady range determination system which determines a steady range of a multilevel signal in operation data containing the multilevel signal, the steady range determination program causing a computer to execute:
a conversion process of setting at least one threshold value for the multilevel signal contained in the operation data, and converting the multilevel signal into at least one binary signal with using the threshold value;
a prediction process of inputting the binary signal converted by the conversion process to a prediction model which predicts a steady-state signal value of the operation data, and calculating a prediction value of the binary signal converted by the conversion process, as a converted binary signal prediction value; and
a range determination process of calculating, based on the converted binary signal prediction value and the threshold value, a probability that a signal value of the multilevel signal contained in the operation data exists in a range determined based on the threshold value, and determining the steady range of the multilevel signal contained in the operation data, on a basis of the probability.
